(19) United States
(12) Patent Application Publication
(10) Pub. No.: US 2023/0168414 A1
(43) Pub. Date: Jun. 1, 2023

(54) LIGHT-SHIELDING MEMBER AND HEAD-MOUNTED DISPLAY

(71) Applicant: Sony Interactive Entertainment Inc., Tokyo (JP)

(72) Inventors: Jun Sakamoto, Tokyo (JP); Yoshiyuki Otsuka, Tokyo (JP)

(73) Assignee: Sony Interactive Entertainment Inc., Tokyo (JP)

(21) Appl. No.: 18/054,952

(22) Filed: Nov. 14, 2022

(30) Foreign Application Priority Data
Nov. 29, 2021 (JP) 2021-193205

(51) Int. Cl. G02B 5/00

(52) U.S. Cl. CPC G02B 5/005

(57) ABSTRACT

Provided is a light-shielding member that reduces external light to be incident to the eyes of a user who is wearing a head-mounted display, the light-shielding member including a nose accommodation portion including a front portion, a right portion, and a left portion that cooperatively form a space in which the nose of the user is to be accommodated, the right portion including a right inclined portion that is inclined downwardly toward the right and that is to elastically come into contact with at least part of an inner side portion of a right lens edge of eyeglasses worn by the user, the left portion including a left inclined portion that is inclined downwardly toward the left and that is to elastically come into contact with at least part of an inner side portion of a left lens edge of the eyeglasses worn by the user.

### CROSS REFERENCE TO RELATED APPLICATION

This application claims the benefit of Japanese Priority Patent Application JP 2021-193205 filed Nov. 29, 2021, the entire contents of which are incorporated herein by reference.

### BACKGROUND

The present technology relates to a light-shielding member and a head-mounted display.

Among head-mounted displays, there is known a head-mounted display which includes a light-shielding member (sometimes called a light shield) that reduces external light to be incident to the eyes of a user as disclosed, for example, in PCT Patent Publication No. WO2016/136657.

### SUMMARY

In a case where a head-mounted display that includes a light-shielding member is used by a user in a state in which the user is wearing eyeglasses, the posture of the eyeglasses sometimes become unstable.

The present technology has been made in view of the subject describe above, and it is desirable to provide a light-shielding member and a head-mounted display by which the posture of eyeglasses is stabilized.

According to a mode of the present disclosure, there is provided a light-shielding member that reduces external light to be incident to the eyes of a user who is wearing a head-mounted display, the light-shielding member having a nose accommodation portion including a front portion, a right portion, and a left portion that cooperatively form a space in which the nose of the user is to be accommodated, the right portion including a right inclined portion that is inclined downwardly toward the right and that is to elastically come into contact with at least part of an inner side portion of a right lens edge of eyeglasses worn by the user, the left portion including a left inclined portion that is inclined downwardly toward the left and that is to elastically come into contact with at least part of an inner side portion of a left lens edge of the eyeglasses worn by the user.

According to another mode of the present disclosure, there is provided a head-mounted display including a housing, a mounting band that extends rearwardly from the housing and that is to be mounted on the head of the user, and a light-shielding member that reduces external light to be incident to the eyes of a user, the light-shielding member including a nose accommodation portion including a front portion, a right portion, and a left portion that cooperatively form a space in which the nose of the user is to be accommodated, the right portion including a right inclined portion that is inclined downwardly toward the right and that is to elastically come into contact with at least part of an inner side portion of a right lens edge of eyeglasses worn by the user, the left portion including a left inclined portion that is inclined downwardly toward the left and that is to elastically come into contact with at least part of an inner side portion of a left lens edge of the eyeglasses worn by the user.

### BRIEF DESCRIPTION OF THE DRAWINGS

FIG. 1 is a perspective view depicting a general configuration of a head-mounted display according to a first embodiment of the present technology;

FIG. 2 is a perspective view of a light-shielding member of the first embodiment as viewed from the front diagonally;

FIG. 3 is a front elevational view of the light-shielding member of the first embodiment as viewed from the front;

FIG. 4 is a perspective view of the light-shielding member of the first embodiment as viewed from the back diagonally;

FIG. 5 is a rear elevational view of the light-shielding member of the first embodiment as viewed from the back;

FIG. 6 is a top plan view of the light-shielding member of the first embodiment as viewed from above;

FIG. 7 is a bottom plan view of the light-shielding member of the present embodiment as viewed from below;

FIG. 8 is a perspective view of the light-shielding member of the first embodiment as viewed from below diagonally;

FIG. 9 is a rear elevational view of part of a head-mounted display to which a light-shielding member of a second embodiment is attached as viewed from the back;

FIG. 10 is a perspective view of the head-mounted display to which the light-shielding member of the second embodiment is attached as viewed from the back diagonally;

FIG. 11 is a perspective view of the light-shielding member of the second embodiment as viewed from below diagonally;

FIG. 12 is an enlarged view illustrating details of the shape of a nose accommodation portion of the light-shielding member of the second embodiment;

FIG. 13 is a rear elevational view of part of the head-mounted display to which the light-shielding member of the second embodiment is attached and eyeglasses worn by a user as viewed from the back; and

FIG. 14 is a perspective view of the head-mounted display to which the light-shielding member of the second embodiment is attached and the eyeglasses worn by the user as viewed from the back diagonally.

### DETAILED DESCRIPTION OF THE PREFERRED EMBODIMENTS

In the following, embodiments of the present technology are described with reference to the accompanying drawings. In the following description, directions indicated by X1 and X2 in the figures are rightward and leftward directions, respectively; directions indicated by Y1 and Y2 in the figures are forward and backward directions, respectively; and directions indicated by Z1 and Z2 in the figures are upward and downward directions, respectively. The directions mentioned indicate directions as viewed from a user who is wearing a head-mounted display (HMD) 1. Further, in the description given below, the head-mounted display 1 is referred to as the HMD 1.

### First Embodiment

### [Overview of General Configuration of HMD 1]

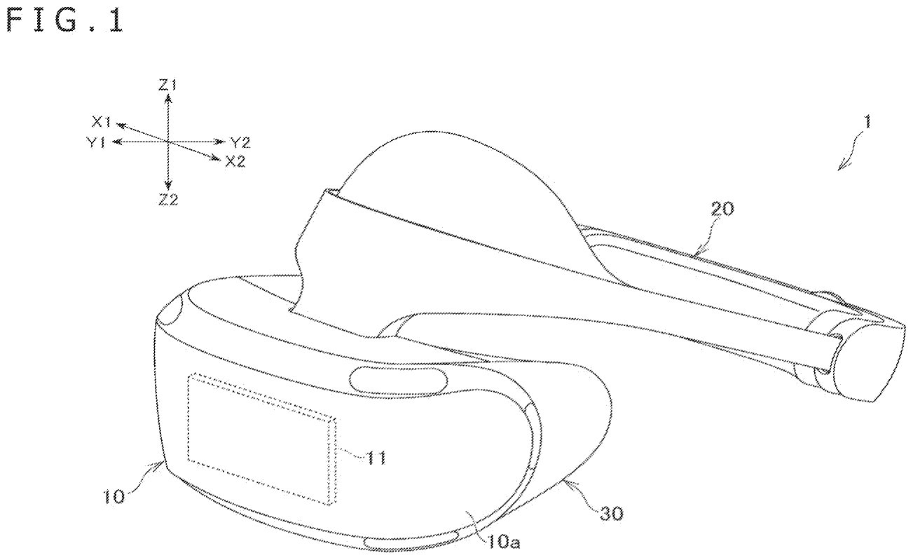

FIG. 1 is a perspective view depicting a general configuration of the HMD according to the first embodiment. As depicted in FIG. 1, the HMD 1 includes a device main body 10 and a mounting band 20.

The mounting band 20 extends rearwardly from the device main body 10. When the HMD 1 is to be used, the mounting band 20 surrounds the head of a user. The mounting band 20 preferably has an annular shape such that the head of the user is placed in the inside of the same.

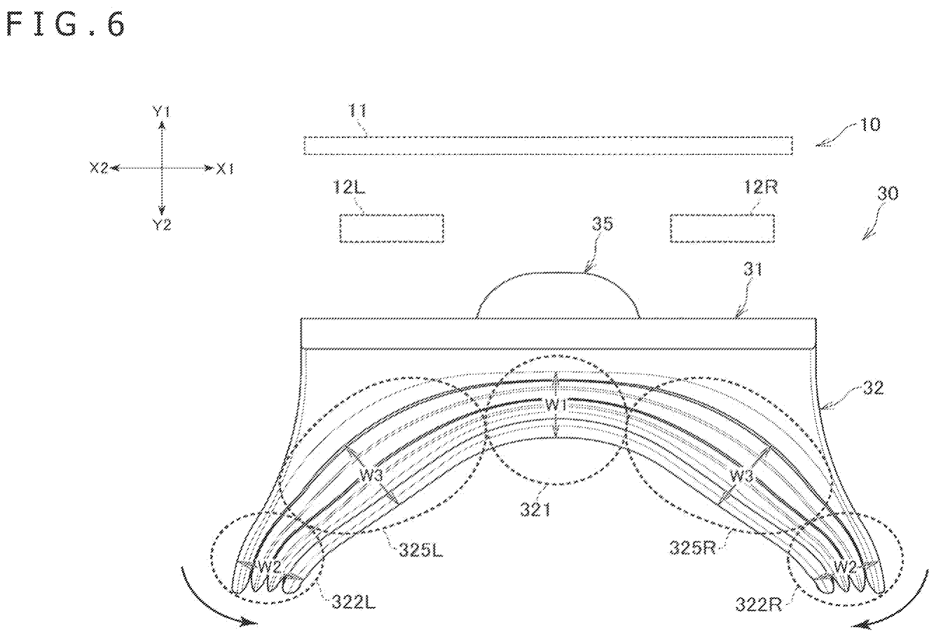

The device main body 10 includes at least a display 11, a right lens 12R and a left lens 12L (refer to FIG. 6), and a housing 10a that accommodates the display 11, the right lens 12R, and the left lens 12L therein and configures the exterior of the device main body 10. In an example of the HMD 1, the display 11 displays a three-dimensional image. However, this is not restrictive, and the image to be displayed on the display 11 may be a two-dimensional image. While the display 11 is, for example, preferably a liquid crystal display device or an organic electroluminescence display device, the type of the display 11 is not restricted to any specific kind. When the HMD 1 is used, the device main body 10 covers the front of the eyes of the user. The housing 10a is, for example, preferably made of resin.

It is to be noted that, although an example in which the housing 10a has a display built therein is described in the description of the first embodiment, this is not restrictive. For example, the housing 10a may be configured such that a portable terminal is accommodated in the device main body 10 and image light from the display of the accommodated portable terminal is introduced to the eyes of the user. In this case, for example, a smartphone is preferably used as the portable terminal.

The mounting band 20 may be configured such that it supports the device main body 10 for relative movement in the forward and rearward directions with respect to the device main body 10. Such a configuration as just described makes it possible to adjust the distance between the eyes of the user and the right lens 12R and the left lens 12L. Further, together with this, it is possible to adjust the distance of a light-shielding member 30 hereinafter described with respect to the face of the user to thereby adjust the contact pressure to the face of the user. Further, the mounting band 20 may be structured such that the length thereof can be adjusted according to the size of the head of the user. It is to be noted that it is sufficient if the mounting band 20 is mounted on the head of the user and supports the device main body 10, and the configuration of the mounting band 20 depicted in FIG. 1 is not restrictive.

### [Light-Shielding Member]

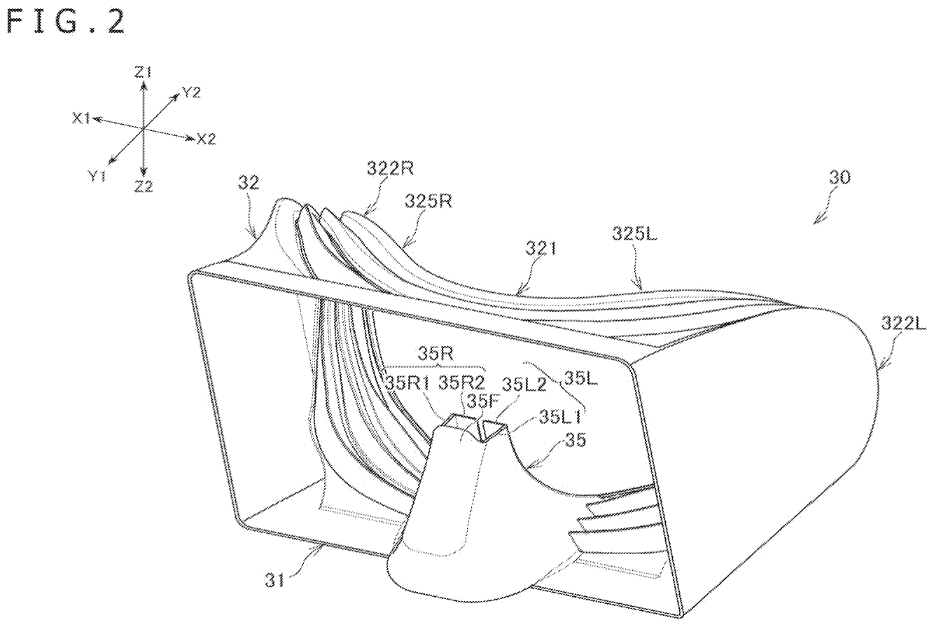

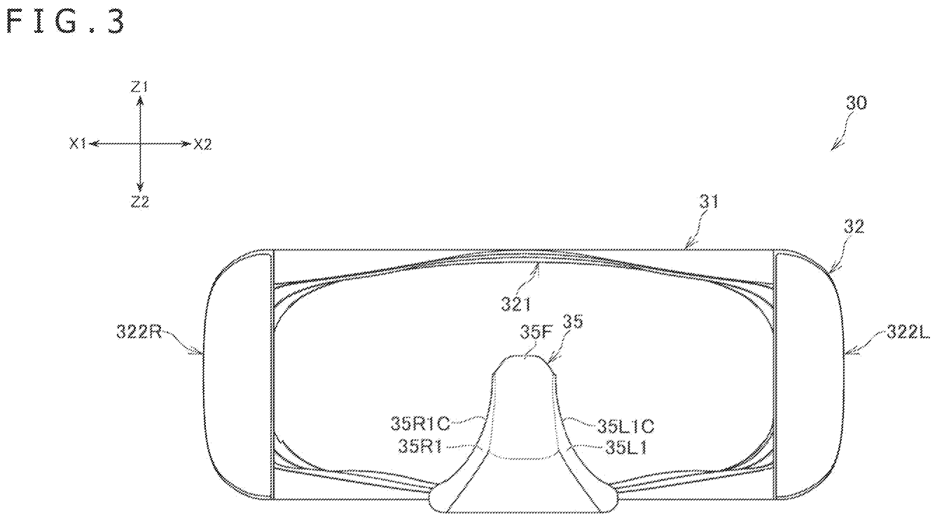

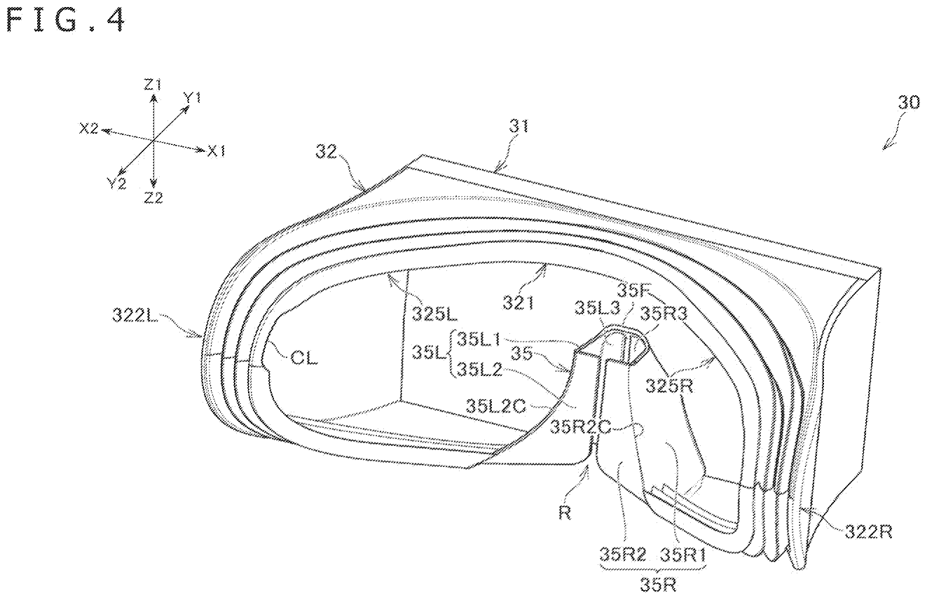

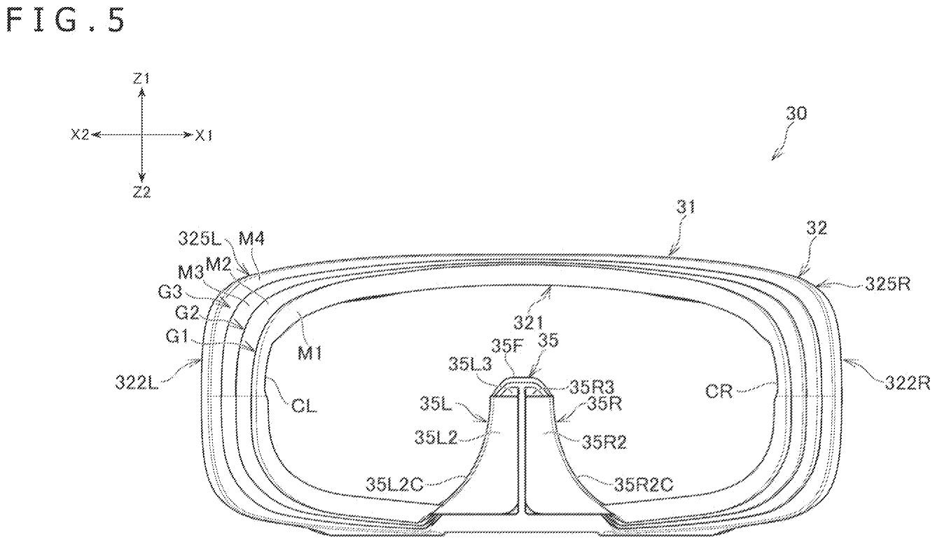

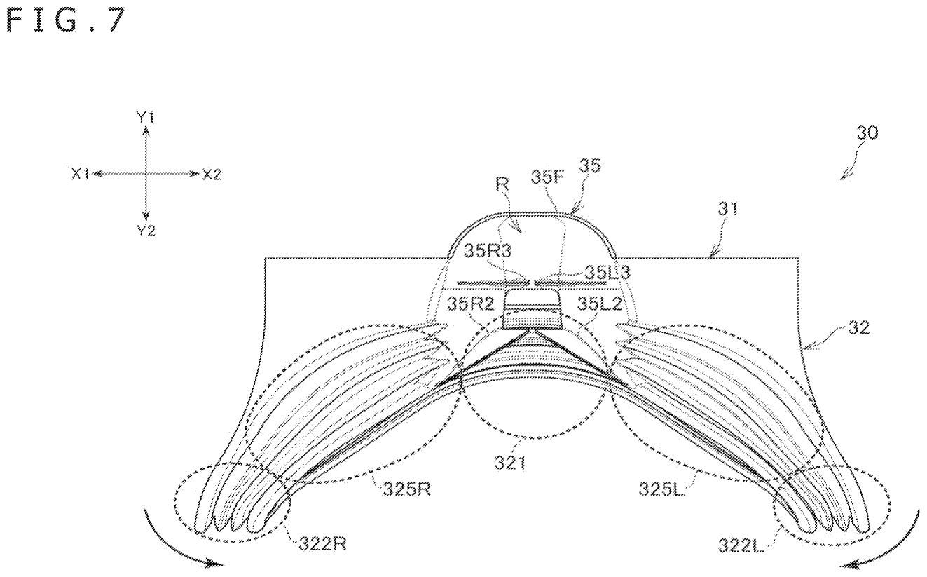

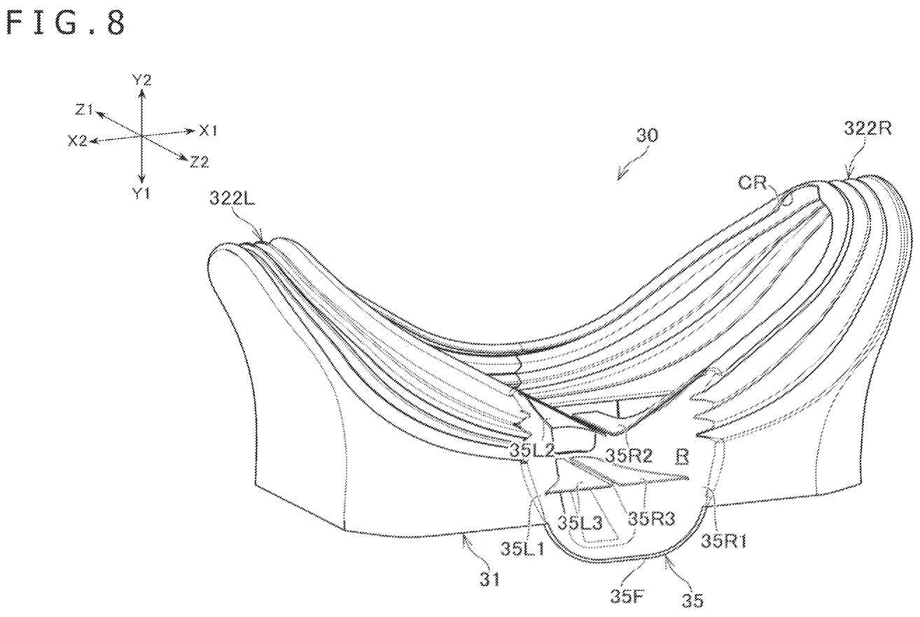

Now, details of the light-shielding member 30 of the first embodiment are described with reference to FIGS. 2 to 8. FIG. 2 is a perspective view of the light-shielding member of the first embodiment as viewed from the front diagonally. FIG. 3 is a front elevational view of the light-shielding member of the first embodiment as viewed from the front. FIG. 4 is a perspective view of the light-shielding member of the first embodiment as viewed from the back diagonally. FIG. 5 is a rear elevational view of the light-shielding member of the first embodiment as viewed from the back. FIG. 6 is a top plan view of the light-shielding member of the first embodiment as viewed from above. In FIG. 6, part of the internal structure of the device main body 10 is depicted schematically. FIG. 7 is a bottom plan view of the light-shielding member of the present embodiment as viewed from below. FIG. 8 is a perspective view of the light-shielding member of the first embodiment as viewed from below diagonally.

The light-shielding member 30 is a member that is provided in order to intercept or reduce external light to be incident to the eyes of the user who is wearing the HMD 1. The light-shielding member 30 is preferably made of resin having elasticity. However, the light-shielding member 30 is not limited to a member made of resin and may be made of, for example, fibrous material (sponge or the like).

The light-shielding member 30 includes an attachment portion 31 at which the light-shielding member 30 is attached to the housing 10a of the device main body 10. The attachment portion 31 preferably has an annular shape that encloses, as viewed from the back, the right lens 12R and the left lens 12L accommodated in the housing 10a. Further, the attachment portion 31 is preferably configured to be mountable and dismountable on and from the housing 10a. For example, preferably, a plurality of locking projections are formed at a front portion of the attachment portion 31 such that they are fitted in a plurality of grooves formed on the housing 10a, to allow the light-shielding member 30 to be attached to the housing 10a. However, this is not restrictive, and the attachment portion 31 may be formed fixedly on the housing 10a by two-color molding or insert molding.

Further, the light-shielding member 30 includes a light-shielding wall 32 extending rearwardly from the attachment portion 31. The light-shielding wall 32 extends rearwardly from the attachment portion 31 such that it comes into contact with the periphery of the eyes of the user who is wearing the HMD 1. Since the light-shielding member 30 includes the light-shielding wall 32, it demonstrates a function of intercepting or reducing external light to be incident to the eyes of the user who is wearing the HMD 1. It is to be noted that the attachment portion 31 and the light-shielding wall 32 are preferably integrated with each other.

The light-shielding wall 32 includes an upper portion 321, a right portion 322R, and a left portion 322L. The upper portion 321 is a portion that comes into contact with the upper side of the eyes of the user who is wearing the HMD 1. The right portion 322R is a portion that comes into contact with the right side of the right eye of the user who is wearing the HMD 1. The left portion 322L is a portion that comes into contact with the left side of the left eye of the user who is wearing the HMD 1.

Further, the light-shielding wall 32 includes a right connection portion 325R that connects the upper portion 321 and the right portion 322R to each other and a left connection portion 325L that connects the upper portion 321 and the left portion 322L to each other.

Described with reference to FIGS. 6 and 7, portions corresponding to the upper portion 321, the right portion 322R, the left portion 322L, the right connection portion 325R, and the left connection portion 325L are each indicated by a broken line circle. It is to be noted that the light-shielding wall 32 includes a single member and the boundaries of the portions mentioned are not defined in a precise manner.

Further, the light-shielding wall 32 has bellows that come into contact with the periphery of the eyes of the user who is wearing the HMD 1 and deform to expand and contract in response to the contact pressure. In the description of the first embodiment, an example in which the bellows are provided over the overall periphery of the light-shielding wall 32 is described. In particular, depicted is an example in which the bellows are provided on each of the upper portion 321, the right portion 322R, the left portion 322L, the right connection portion 325R, and the left connection portion 325L.

Here, the bellows include mountain portions and valley portions formed alternately. In the first embodiment, bellows having four mountain portions M1 to M4 and three valley portions G1 to G3 formed alternately thereon are depicted. It is to be noted that, in order to avoid complicated illustration of the figures, the reference characters of the mountain portions and the valley portions are depicted only in FIG. 5. The numbers of the mountain portions and the valley portions are not restricted to them and may be greater or smaller than those of the example depicted. If the numbers of the mountain portions and the valley portions are increased, then the expansion and contraction performance of the light-shielding wall 32 can be improved. On the other hand, if the numbers of the mountain portions and the valley portions are decreased, then the configuration of the light-shielding wall 32 can be simplified.

Further, in the first embodiment, cutouts CR and CL are provided at the innermost mountain portion M1 of the bellows at the right portion 322R and the left portion 322L, respectively, as depicted in FIG. 5 and so forth. The cutouts CR and CL are provided in front of the ears of the user who is wearing the HMD 1 and have a predetermined dimension in the upward and downward directions. Since the cutouts CR and CL are provided in this manner, even in a case where the user wears the HMD 1 in a state in which the user is wearing eyeglasses, it can be suppressed that the temples of the eyeglasses interfere with the right portion 322R and the left portion 322L of the light-shielding wall 32 to deform the light-shielding wall 32 to such a degree that a gap is formed between the light-shielding wall 32 and the face of the user. Further, since the temples of the eyeglasses are avoided from interfering with the right portion 322R and the left portion 322L of the light-shielding wall 32, also in a state in which the user is wearing eyeglasses, the user can wear the HMD 1 without any uncomfortable feeling.

It is to be noted that the cutouts CR and CL are preferably provided at least at portions of the right portion 322R and the left portion 322L that include the innermost mountain portion or valley portion. For example, the cutouts CR and CL may be provided across the innermost mountain portion M1 and the valley portion G1 adjacent to the mountain portion M1. Further, for example, in a case where a valley portion of the bellows at the right portion 322R and the left portion 322L is provided on the innermost side, the cutouts CR and CL are preferably provided at the innermost valley portion.

Here, in the first embodiment, as illustrated in FIG. 6, the width W3 of the bellows at the right connection portion 325R and the left connection portion 325L as viewed from above is made greater than the width W1 of the bellows at the upper portion 321 and the width W2 of the bellows at the right portion 322R and the left portion 322L. Owing to such a configuration as just described, when the user tries to wear the HMD 1, the head of the user is first brought into contact with the right connection portion 325R and the left connection portion 325L. Consequently, the right connection portion 325R and the left connection portion 325L are compression-deformed.

As the right connection portion 325R and the left connection portion 325L are compression-deformed, the right portion 322R moves to the left while the left portion 322L moves to the right. In other words, the right portion 322R and the left portion 322L move in the directions indicated by arrow marks in FIGS. 6 and 7. Consequently, the head of the user is sandwiched by the right portion 322R and the left portion 322L. In particular, the right portion 322R comes into contact with the right side of the right eye of the user with a predetermined contact pressure while the left portion 322L comes into contact with the left side of the left eye of the user with a predetermined contact pressure. It is to be noted that, in the first embodiment, the right portion 322R moves to the left by bending of the light-shielding wall 32 at the boundary (inflection point) between the right portion 322R and the right connection portion 325R. Similarly, the left portion 322L moves to the right by bending of the light-shielding wall 32 at the boundary (inflection point) between the left portion 322L and the left connection portion 325L.

As described above, the right connection portion 325R connects the upper portion 321 and the right portion 322R to each other such that, as the contact pressure to the right connection portion 325R increases, the right portion 322R comes closer to the face of the user. Similarly, the left connection portion 325L connects the upper portion 321 and the left portion 322L to each other such that, as the contact pressure to the left connection portion 325L increases, the left portion 322L comes closer to the face of the user.

Further, in the first embodiment, the right portion 322R and the right connection portion 325R extend diagonally to the right and backward as viewed from above. Further, the left portion 322L and the left connection portion 325L extend diagonally to the left and backward as viewed from above. In particular, the light-shielding wall 32 has a substantially V shape as viewed from above. Since the light-shielding wall 32 is shaped in such a manner as just described, the face of the user who is wearing the HMD 1 easily comes into contact with the light-shielding wall 32 in comparison with the case of an alternative configuration in which the right portion 322R, the right connection portion 325R, the left portion 322L, and the left connection portion 325L extend straightly rearwardly. Therefore, it is possible to suppress generation of a gap between the face of the user and the light-shielding wall 32.

Since such a configuration as described above is adopted, even in a case where a user with a small head wears the HMD 1, the right portion 322R and the left portion 322L move in such a manner that they come closer to the face of the user, and hence, entrance of external light through a gap between the right portion 322R and left portion 322L and the face of the user is suppressed. As a result, incidence of external light to the eyes of the user is suppressed.

Further, in a case where a user with a large head wears the HMD 1, since the light-shielding wall 32 includes the bellows that deform to expand and contract in response to the contact pressure, the contact pressure acting upon the face of the user is moderated. As a result, an uncomfortable feeling arising from the contact of the light-shielding wall 32 with the face of the user can be suppressed.

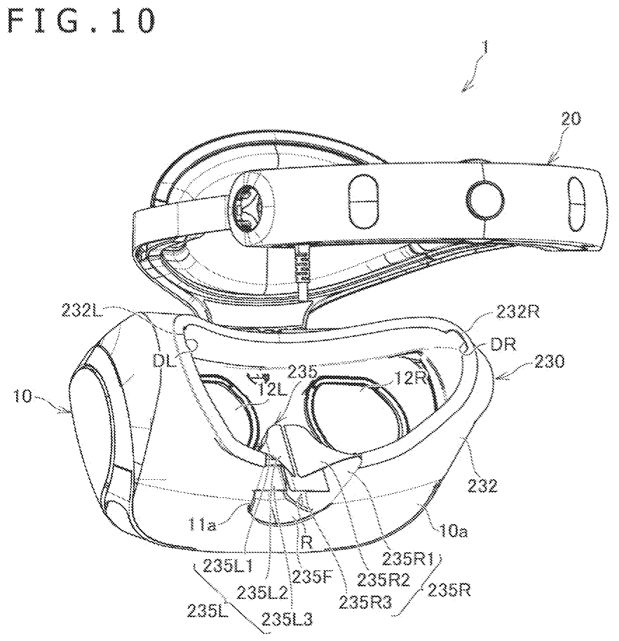

Furthermore, the light-shielding member 30 includes, at a lower portion thereof, a nose accommodation portion 35 in which the nose of the user who is wearing the HMD 1 is to be accommodated. The nose accommodation portion 35 is configured integrally with the light-shielding wall 32 at a lower portion of the light-shielding wall 32. The nose accommodation portion 35 is preferably made of resin having elasticity similarly to the light-shielding wall 32. The nose accommodation portion 35 is preferably formed in such a manner as to project forwardly such that, in a state in which the light-shielding member 30 is attached to the housing 10a, it is fitted in a recessed portion (not depicted in the figures that depict the first embodiment; refer to FIG. 10 that depicts a second embodiment hereinafter described) formed at a lower portion of the housing 10a. Since the light-shielding member 30 includes the nose accommodation portion 35 in this manner, an uncomfortable feeling arising from interference of the light-shielding wall 32 with the nose of the user who is wearing the HMD 1 can be suppressed.

The nose accommodation portion 35 includes a front portion 35F that configures a front side portion of the nose accommodation portion 35, a right portion 35R that configures a right side portion of the nose accommodation portion 35, and a left portion 35L that configures a left side portion of the nose accommodation portion 35, and is open downwardly and rearwardly. The nose of the user who is wearing the HMD 1 is placed in a space R enclosed by the front portion 35F, the right portion 35R, and the left portion 35L.

The right portion 35R includes a right side portion 35R1 extending rearwardly from the front portion 35F and a first right light-shielding portion 35R2 that extends to the left from the right side portion 35R1 such that it reduces external light to be incident to the eyes of the user through a gap between the nose accommodation portion 35 and the nose of the user. The left portion 35L includes a left side portion 35L1 extending rearwardly from the front portion 35F and a first left light-shielding portion 35L2 that extends to the right from the left side portion 35L1 such that it reduces external light to be incident to the eyes of the user through a gap between the nose accommodation portion 35 and the nose of the user. The first right light-shielding portion 35R2 and the first left light-shielding portion 35L2 preferably have a sheet-like configuration. In the first embodiment, the first right light-shielding portion 35R2 and the first left light-shielding portion 35L2 are spaced away from each other in the leftward and rightward directions as depicted in FIG. 5 and so forth such that a slit that extends in the upward and downward directions is formed between them.

The nose of the user who is wearing the HMD 1 is accommodated in the space R through the slit formed between the first right light-shielding portion 35R2 and the first left light-shielding portion 35L2. Since the nose accommodation portion 35 includes the first right light-shielding portion 35R2 and the first left light-shielding portion 35L2 in this manner, entrance of external light through a gap between the right portion 35R and the left portion 35L of the nose accommodation portion 35 and the nose of the user can be suppressed. As a result, incidence of external light to the eyes of the user can be suppressed.

Further, the right portion 35R includes a second right light-shielding portion 35R3 that extends to the left from the right side portion 35R1 such that it reduces external light to be incident to the eyes of the user through a gap between the nose accommodation portion 35 and the nose of the user and that is arranged in front of the first right light-shielding portion 35R2. The left portion 35L includes a second left light-shielding portion 35L3 that extends to the right from the left side portion 35L1 such that it reduces external light to be incident to the eyes of the user through a gap between the nose accommodation portion 35 and the nose of the user and that is arranged in front of the first left light-shielding portion 35L2. The second right light-shielding portion 35R3 and the second left light-shielding portion 35L3 preferably have a sheet-like configuration. The second right light-shielding portion 35R3 and the second left light-shielding portion 35L3 are arranged in such a manner as to divide the space R into two spaces in the forward and rearward directions. Further, the second right light-shielding portion 35R3 and the second left light-shielding portion 35L3 are spaced away from each other in the leftward and rightward directions such that a slit that extends in the upward and downward directions is formed between them.

In a case where a user with a large nose (with a nose whose length in the forward and rearward directions is great) wears the HMD 1, the nose of the user is accommodated in the space R through the slit formed between the first right light-shielding portion 35R2 and the first left light-shielding portion 35L2 and the slit formed between the second right light-shielding portion 35R3 and the second left light-shielding portion 35L3. By such a configuration as just described, entrance of external light through a gap between the right portion 35R and the left portion 35L of the nose accommodation portion 35 and the nose of the user can be suppressed.

As depicted in FIGS. 4 and 5, for example, the right portion 35R includes a right inclined portion that is inclined downwardly toward the right and that elastically comes into contact with at least part of an inner side portion of the right lens edge of the eyeglasses worn by the user. The right inclined portion includes a right inclined face 35R2C that is a right edge of the first right light-shielding portion 35R2 and a portion of the right side portion 35R1 that is inclined in such a manner as to extend along the right inclined face 35R2C.

Similarly, the left portion 35L includes a left inclined portion that is inclined downwardly toward the left and that elastically comes into contact with at least part of an inner side portion of the left lens edge of the eyeglasses worn by the user. The left inclined portion includes a left inclined face 35L2C that is a left edge of the first left light-shielding portion 35L2 and a portion of a left side portion 35L1 that is inclined in such a manner as to extend along the left inclined face 35L2C.

In the HMD 1 according to the first embodiment described above, in a case where it is used by a user with a small head, incidence of external light to the eyes of the user can be suppressed, and as a result, an improved sense of immersion can be provided to the user. On the other hand, in a case where the HMD 1 is used by a user with a large head, it can be suppressed that the user has an uncomfortable feeling due to the contact pressure of the light-shielding member 30.

Further, since the nose accommodation portion 35 includes the inclined portions that elastically come into contact with at least part of the inner side portions of lens edges of the eyeglasses, even in a case where the user uses the HMD 1 in a state in which the user is wearing eyeglasses, the posture of the eyeglasses can be stabilized. In other words, it can be suppressed that the eyeglasses suffer from positional displacement in the forward or backward direction or from oblique inclination. As a result, it can be suppressed that, due to contact of a lens edge or the like of the eyeglasses with the right lens 12R or the left lens 12L of the HMD 1, the right lens 12R or the left lens 12L is damaged or stained.

It is to be noted that the light-shielding member 30 presented in the first embodiment is an example, and it is sufficient if the light-shielding wall 32 includes at least at part thereof bellows that are deformed to expand and contract in response to the contact pressure. Further, the light-shielding wall 32 is not limited to one that includes bellows, and it is sufficient if the light-shielding wall 32 is at least elastically deformed in response to the contact pressure.

### Second Embodiment

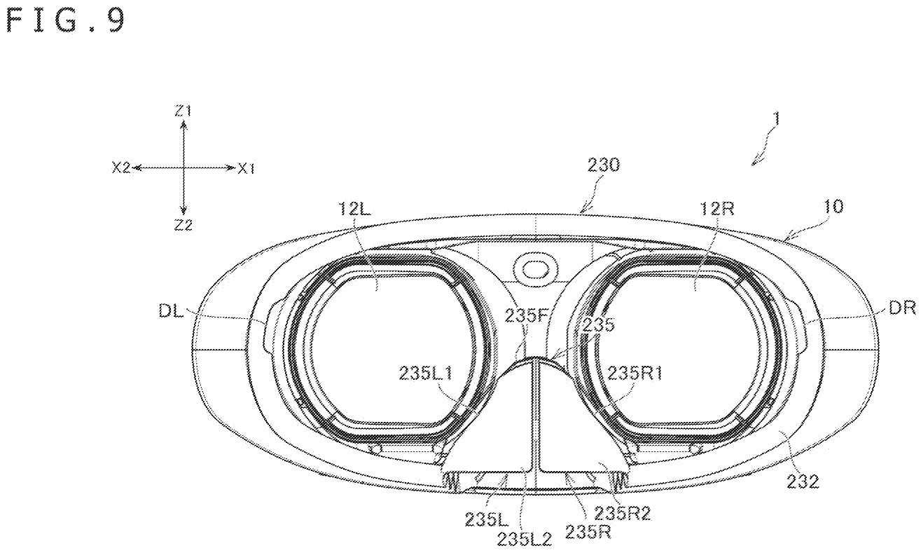

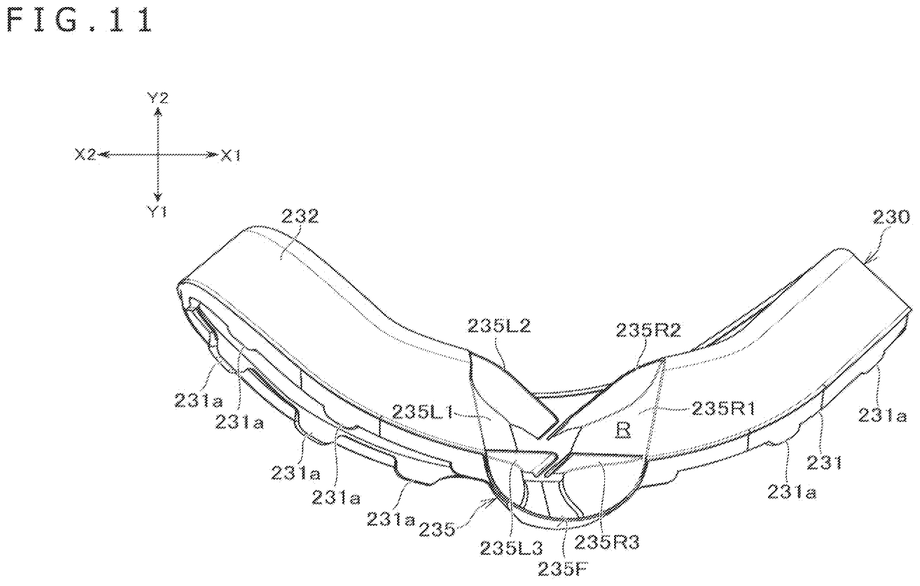

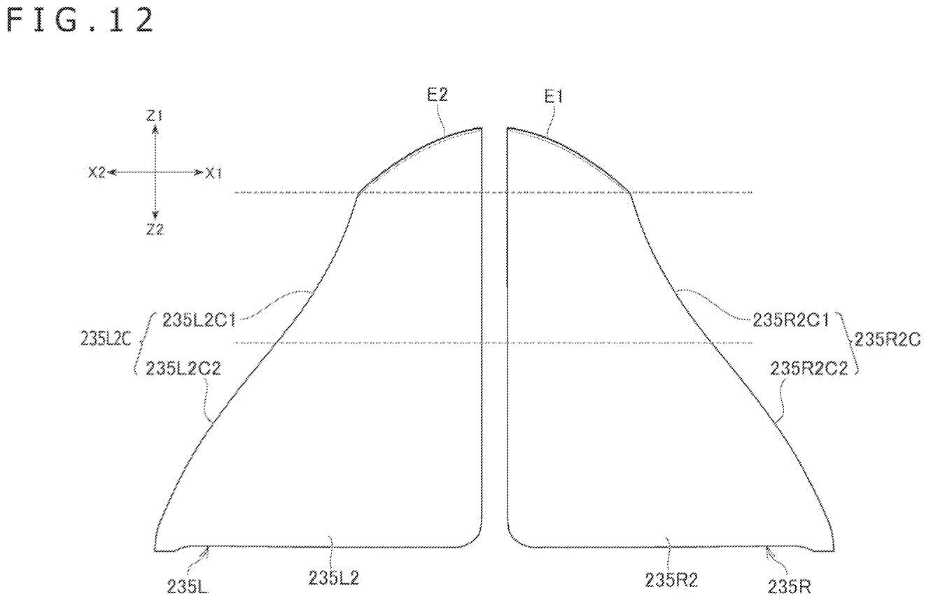

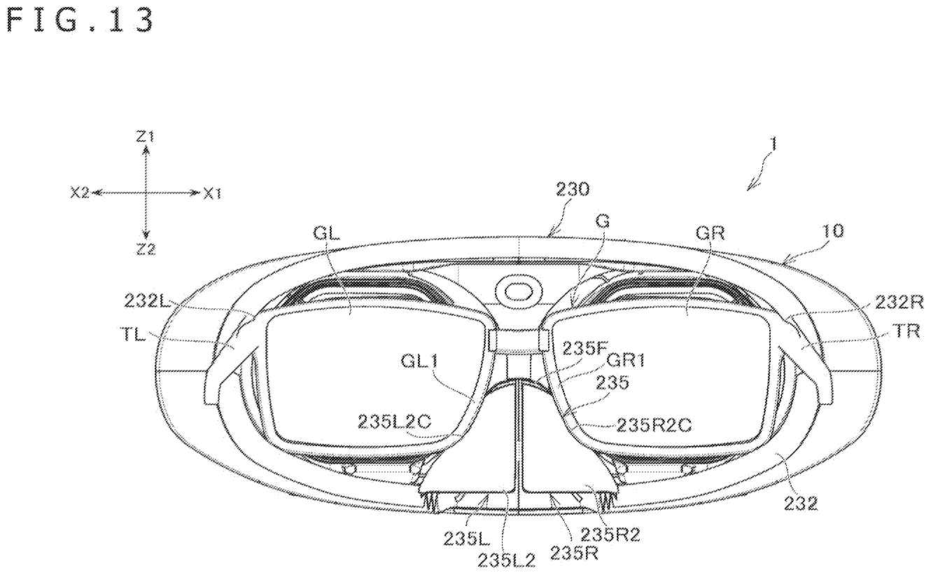

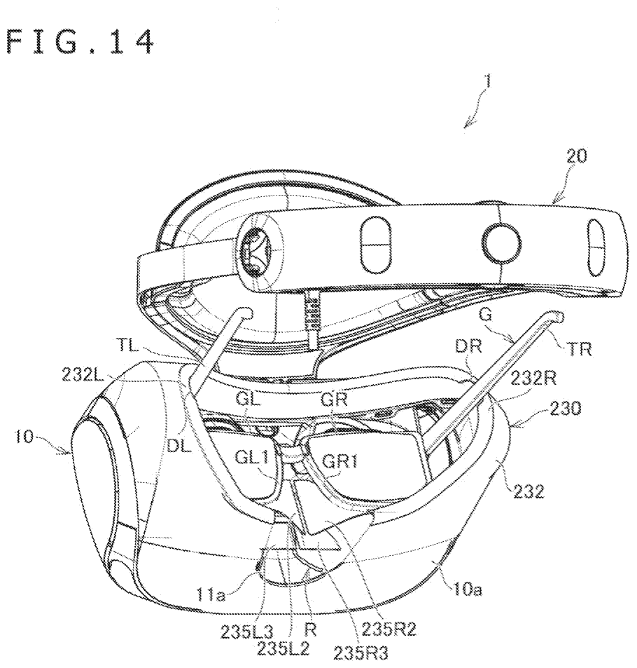

Now, details of a light-shielding member 230 according to a second embodiment are described with reference to FIGS. 9 to 14. FIG. 9 is a rear elevational view of part of a head-mounted display to which the light-shielding member of the second embodiment is attached as viewed from the back. FIG. 10 is a perspective view of the head-mounted display to which the light-shielding member of the second embodiment is attached as viewed from the back diagonally. FIG. 11 is a perspective view of the light-shielding member of the second embodiment as viewed from below diagonally. FIG. 12 is an enlarged view illustrating details of the shape of a nose accommodation portion of the light-shielding member of the second embodiment. FIG. 13 is a rear elevational view of part of the head-mounted display to which the light-shielding member of the second embodiment is attached and eyeglasses worn by a user as viewed from the back. FIG. 14 is a perspective view of the head-mounted display to which the light-shielding member of the second embodiment is attached and the eyeglasses worn by the user as viewed from the back diagonally. It is to be noted that, although eyeglasses G worn by a user are depicted in FIGS. 13 and 14, illustration of the user itself is omitted in FIGS. 13 and 14.

In the second embodiment, adopted is a configuration by which, even in a case where a user uses the HMD 1 in a state in which the user is wearing the eyeglasses G, the posture of the eyeglasses G can further be stabilized. It is to be noted that similar components having functions identical to those described hereinabove in connection with the first embodiment are denoted by the same reference characters and detailed overlapping description of them is omitted here.

The light-shielding member 230 is a member that is provided in order to intercept or reduce external light to be incident to the eyes of the user who is wearing the HMD 1. The light-shielding member 230 is preferably made of resin having elasticity. However, the light-shielding member 230 is not limited to a member made of resin and may be made of, for example, fibrous material (sponge or the like).

The light-shielding member 230 includes an attachment portion 231 at which the light-shielding member 230 is attached to the housing 10a of the device main body 10 as depicted in FIG. 11. The attachment portion 231 preferably has an annular shape that encloses, as viewed from the back, the right lens 12R and the left lens 12L accommodated in the housing 10a. Further, the attachment portion 231 is preferably configured to be mountable and dismountable on and from the housing 10a. For example, a plurality of locking projections 231a are preferably formed at a front portion of the attachment portion 231 such that they are fitted in a plurality of grooves formed on the housing 10a, to allow the light-shielding member 230 to be attached to the housing 10a. However, this is not restrictive, and the attachment portion 231 may be formed fixedly on the housing 10a by two-color molding or insert molding.

Further, the light-shielding member 230 includes a light-shielding wall 232 extending rearwardly from the attachment portion 231. The light-shielding wall 232 extends rearwardly from the attachment portion 231 such that it comes into contact with the periphery of the eyes of the user who is wearing the HMD 1. Since the light-shielding member 230 includes the light-shielding wall 232, it demonstrates a function of intercepting or reducing external light to be incident to the eyes of the user who is wearing the HMD 1. It is to be noted that the attachment portion 231 and the light-shielding wall 232 are preferably integrated with each other.

Although the second embodiment is described in connection with an example in which the light-shielding wall 232 does not include bellows that are deformed to expand and contract in response to the contact pressure, this not restrictive, and the light-shielding wall 232 may otherwise include bellows. The light-shielding wall 232 is at least preferably made of an elastic material that is elastically deformed in response to the contact pressure.

The light-shielding member 230 includes, at a lower portion thereof, a nose accommodation portion 235 in which the nose of the user who is wearing the HMD 1 is to be accommodated. The nose accommodation portion 235 is configured integrally with the light-shielding wall 232 at a lower portion of the light-shielding wall 232. The nose accommodation portion 235 is preferably made of resin having elasticity similarly to the light-shielding wall 232.

As depicted in FIGS. 10 and 11, the nose accommodation portion 235 is shaped to project forwardly and is located, at least at part thereof, in front of the attachment portion 231. Further, the housing 10a has a recessed portion 11a in which the portion of the nose accommodation portion 235 located in front of the attachment portion 231 is placed. Since the housing 10a has the recessed portion 11a in this manner, the nose accommodation portion 235 can be provided with an increased dimension in the forward and backward directions.

Since the light-shielding member 230 includes the nose accommodation portion 235, an uncomfortable feeling arising from interference of the light-shielding wall 232 with the nose of the user who is wearing the HMD 1 can be suppressed.

The nose accommodation portion 235 includes a front portion 235F that configures a front side portion of the nose accommodation portion 235, a right portion 235R that configures a right side portion of the nose accommodation portion 235, and a left portion 235L that configures a left side portion of the nose accommodation portion 235, and is open downwardly and rearwardly. The nose of the user who is wearing the HMD 1 is placed in a space R enclosed by the front portion 235F, the right portion 235R, and the left portion 235L.

The right portion 235R includes a right side portion 235R1 extending rearwardly from the front portion 235F and a first right light-shielding portion 235R2 that extends to the left from the right side portion 235R1 such that it reduces external light to be incident to the eyes of the user through a gap between the nose accommodation portion 235 and the nose of the user. The left portion 235L includes a left side portion 235L1 extending rearwardly from the front portion 235F and a first left light-shielding portion 235L2 that extends to the right from the left side portion 235L1 such that it reduces external light to be incident to the eyes of the user through a gap between the nose accommodation portion 235 and the nose of the user. The first right light-shielding portion 235R2 and the first left light-shielding portion 235L2 preferably have a sheet-like configuration. In the second embodiment, the first right light-shielding portion 235R2 and the first left light-shielding portion 235L2 are spaced away from each other in the leftward and rightward direction as depicted in FIG. 9 and so forth, such that a slit that extends in the upward and downward directions is formed between them.

The nose of the user who is wearing the HMD 1 is accommodated in the space R through the slit formed between the first right light-shielding portion 235R2 and the first left light-shielding portion 235L2. Since the nose accommodation portion 235 includes the first right light-shielding portion 235R2 and the first left light-shielding portion 235L2 in this manner, entrance of external light enters through a gap between the right portion 235R and left portion 235L of the nose accommodation portion 235 and the nose of the user can be suppressed. As a result, incidence of external light to the eyes of the user can be suppressed.

Further, the right portion 235R includes a second right light-shielding portion 235R3 that extends to the left from the right side portion 235R1 such that it reduces external light to be incident to the eyes of the user through a gap between the nose accommodation portion 235 and the nose of the user and that is arranged in front of the first right light-shielding portion 235R2. The left portion 235L includes a second left light-shielding portion 235L3 that extends to the right from the left side portion 235L1 such that it reduces external light to be incident to the eyes of the user through a gap between the nose accommodation portion 235 and the nose of the user and that is arranged in front of the first left light-shielding portion 235L2. The second right light-shielding portion 235R3 and the second left light-shielding portion 235L3 preferably have a sheet-like configuration. The second right light-shielding portion 235R3 and the second left light-shielding portion 235L3 are arranged in such a manner as to divide the space R into two spaces in the forward and rearward directions. Further, the second right light-shielding portion 235R3 and the second left light-shielding portion 235L3 are spaced away from each other in the leftward and rightward directions such that a slit that extends in the upward and downward directions is formed between them.

In a case where a user with a large nose (with a nose whose length in the forward and rearward directions is great) wears the HMD 1, the nose of the user is accommodated in the space R through the slit formed between the first right light-shielding portion 235R2 and the first left light-shielding portion 235L2 and the slit formed between the second right light-shielding portion 235R3 and the second left light-shielding portion 235L3. By such a configuration as just described, entrance of external light through a gap between the right portion 235R and the left portion 235L of the nose accommodation portion 235 and the nose of the user can be suppressed.

Here, in eyeglasses that are typically used, an inner side portion and a lower side portion of a right lens edge are connected to each other in a curved manner, and an inner side portion and a lower side portion of a left lens edge are connected to each other in a curved manner. In the nose accommodation portion 235 in the second embodiment, the right portion 235R and the left portion 235L are shaped to extend in line with shapes of lens edges of such typically used eyeglasses. In particular, the right portion 235R and the left portion 235L are shaped in the following manner.

As depicted in FIGS. 12 and 13, the right portion 235R includes a right inclined portion that is inclined downwardly toward the right and that elastically comes into contact with at least part of an inner side portion GR1 of a right lens edge GR of the eyeglasses G worn by the user. The right inclined portion includes a right inclined face 235R2C that is a right edge of the first right light-shielding portion 235R2 and a portion of the right side portion 235R1 that is inclined in such a manner as to extend along the right inclined face 235R2C.

Similarly, the left portion 235L includes a left inclined portion that is inclined downwardly toward the left and that elastically comes into contact with at least part of an inner side portion GL1 of a left lens edge GL of the eyeglasses G worn by the user. The left inclined portion includes a left inclined face 235L2C that is a left edge of the first left light-shielding portion 235L2 and a portion of a left side portion 235L1 that is inclined in such a manner as to extend along the left inclined face 235L2C.

Further, as depicted in FIG. 12, the right inclined face 235R2C includes a first right inclined face 235R2C1 and a second right inclined face 235R2C2 that is located below the first right inclined face 235R2C1 and that is inclined more moderately than the first right inclined face 235R2C1. As depicted in FIG. 12, the first right inclined face 235R2C1 includes a leftwardly recessed shape. It is to be noted that the shape of the right inclined face 235R2C depicted in FIG. 12 is an example, and this is not restrictive. However, at least a lower portion of the right inclined face 235R2C is preferably inclined moderately.

Similarly, the left inclined face 235L2C includes a first left inclined face 235L2C1 and a second left inclined face 235L2C2 that is located below the first left inclined face 235L2C1 and that is inclined more moderately than the first left inclined face 235L2C1. As depicted in FIG. 12, the first left inclined face 235L2C1 includes a rightwardly recessed shape. It is to be noted that the shape of the left inclined face 235L2C depicted in FIG. 12 is a mere example, and this is not restrictive. However, at least a lower portion of the left inclined face 235L2C is preferably inclined moderately.

Since the right portion 235R and the left portion 235L are configured in such a manner as depicted in FIG. 12 and so forth as described above, inner side portions of lens edges of the eyeglasses G worn by the user are supported by the nose accommodation portion 235. Hence, even in a case where the user uses the HMD 1 in a state in which the user is wearing the eyeglasses G, the posture of the eyeglasses G can be stabilized. In particular, it can be suppressed that the eyeglasses G suffer from positional displacement in the forward or backward direction or from oblique inclination. As a result, it can be suppressed that, due to contact of a lens edge or the like of the eyeglasses G with the right lens 12R or the left lens 12L of the HMD 1, the right lens 12R or the left lens 12L is damaged or stained.

Further, in the second embodiment, the light-shielding wall 232 includes a right contacting portion 232R that elastically comes into contact with at least part of a right temple TR of the eyeglasses G worn by the user and a left contacting portion 232L that elastically comes into contact with at least part of a left temple TL of the eyeglasses G as depicted in FIGS. 10 and 14, for example. The right contacting portion 232R includes a bottom face of a right recessed portion DR formed on the light-shielding wall 232, and the left contacting portion 232L includes a bottom face of a left recessed portion DL formed on the light-shielding wall 232. The right recessed portion DR and the left recessed portion DL are provided in front of the ears of the user who is wearing the HMD 1 and have a predetermined dimension in the upward and downward directions.

In a state in which the user is wearing the eyeglasses G, the right temple TR of the eyeglasses G fits in the right recessed portion DR while the left temple TL fits in the left recessed portion DL. Consequently, the eyeglasses G worn by the user elastically come into contact at the inner sides thereof with the right inclined face 235R2C and the left inclined face 235L2C and elastically come into contact at the outer sides thereof with the right contacting portion 232R and the left contacting portion 232L. Since the eyeglasses G worn by the user are supported at the four locations of the light-shielding member 230, the posture thereof is further stabilized.

Further, in the second embodiment, the first right light-shielding portion 235R2 extends forwardly toward the left and the first left light-shielding portion 235L2 extends forwardly toward the right as depicted in FIG. 11. It is to be noted that the first right light-shielding portion 235R2 and the first left light-shielding portion 235L2 are preferably shaped such that they extend in such a manner as depicted in FIG. 11 irrespective of the direction of the light-shielding member 230. In other words, the first right light-shielding portion 235R2 and the first left light-shielding portion 235L2 are preferably shaped to extend in such a manner as depicted in FIG. 11 irrespective of the direction in which the gravity acts.

Since the second embodiment adopts the configuration in which the first right light-shielding portion 235R2 and the first left light-shielding portion 235L2 extend forwardly in this manner, when the user wears the HMD 1, it is suppressed that the first right light-shielding portion 235R2 and the first left light-shielding portion 235L2 are bent backwardly. Consequently, generation of a gap between the nose of the user and the nose accommodation portion 235 can be suppressed. As a result, incidence of external light to the eyes of the user can be suppressed. Further, the contact pressure (repulsive force) of the first right light-shielding portion 235R2 and the first left light-shielding portion 235L2 to the nose of the user is reduced, and as a result, an uncomfortable feeling arising from contact of the nose of the user with the first right light-shielding portion 235R2 and the first left light-shielding portion 235L2 can be suppressed.

Further, in the second embodiment, an upper edge E1 of the first right light-shielding portion 235R2 is inclined downwardly toward the right as depicted in FIG. 12 and so forth. Hence, the angle defined by the upper edge E1 and the right inclined face 235R2C is an obtuse angle. Consequently, it is suppressed that an angular portion defined by the upper edge E1 and the right inclined face 235R2C interferes with the right lens edge GR of the eyeglasses G to cause the nose accommodation portion 235 to suffer from unintentional deformation. As a result, generation of a gap between the nose of the user and the nose accommodation portion 235 can be suppressed.

Similarly, an upper edge E2 of the first left light-shielding portion 235L2 is inclined downwardly toward the left. Hence, the angle defined by the upper edge E2 and the left inclined face 235L2C is an obtuse angle. Consequently, it is suppressed that an angular portion defined by the upper edge E2 and the left inclined face 235L2C interferes with the left lens edge GL of the eyeglasses G to cause the nose accommodation portion 235 to suffer from unintentional deformation. As a result, generation of a gap between the nose of the user and the nose accommodation portion 235 can be suppressed.

It should be understood by those skilled in the art that various modifications, combinations, sub-combinations and alterations may occur depending on design requirements and other factors insofar as they are within the scope of the appended claims or the equivalents thereof

What is claimed is:

1. A light-shielding member that reduces external light to be incident to the eyes of a user who is wearing a head-mounted display, the light-shielding member comprising:
a nose accommodation portion including a front portion, a right portion, and a left portion that cooperatively form a space in which the nose of the user is to be accommodated, wherein
the right portion includes a right inclined portion that is inclined downwardly toward the right and that is to elastically come into contact with at least part of an inner side portion of a right lens edge of eyeglasses worn by the user, and
the left portion includes a left inclined portion that is inclined downwardly toward the left and that is to elastically come into contact with at least part of an inner side portion of a left lens edge of the eyeglasses worn by the user.

2. The light-shielding member according to claim 1, wherein
the right inclined portion includes a first right inclined portion and a second right inclined portion that is located below the first right inclined portion and that is inclined more moderately than the first right inclined portion, and
the left inclined portion includes a first left inclined portion and a second left inclined portion that is located below the first left inclined portion and that is inclined more moderately than the first left inclined portion.

3. The light-shielding member according to claim 1, wherein
the right inclined portion is shaped to be recessed leftwardly at least at part thereof, and
the left inclined portion is shaped to be recessed rightwardly at least at part thereof.

4. The light-shielding member according to claim 1, wherein
the right portion includes a first right light-shielding portion that extends to the left to reduce external light to be incident to the eyes of the user through a gap between the nose accommodation portion and the nose of the user, and
the left portion includes a first left light-shielding portion that extends rightward to reduce external light to be incident to the eyes of the user through a gap between the nose accommodation portion and the nose of the user.

5. The light-shielding member according to claim 4, wherein
the first right light-shielding portion extends forwardly toward the left, and
the first left light-shielding portion extends forwardly toward the right.

6. The light-shielding member according to claim 4, wherein
the right portion further includes a second right light-shielding portion that extends to the left to reduce external light to be incident to the eyes of the user through a gap between the nose accommodation portion and the nose of the user and that is arranged in front of the first right light-shielding portion, and
the left portion further includes a second left light-shielding portion that extends to the right to reduce external light to be incident to the eyes of the user through a gap between the nose accommodation portion and the nose of the user and that is arranged in front of the first left light-shielding portion.

7. The light-shielding member according to claim 4, wherein
the first right light-shielding portion has an upper edge inclined downwardly toward the right, and
the first left light-shielding portion has an upper edge inclined downwardly toward the left.

8. The light-shielding member according to claim 1, further comprising:
a light-shielding wall that is to come into contact with a periphery of the eyes of the user who is wearing the head-mounted display and elastically deforms in response to a contact pressure thereto, wherein
the light-shielding wall includes a right contacting portion that elastically comes into contacts with at least part of a right temple of the eyeglasses worn by the user and a left contacting portion that elastically comes into contact with at least part of a left temple of the eyeglasses worn by the user.

9. The light-shielding member according to claim 8, wherein
the right contacting portion includes a bottom face of a right recessed portion formed on the light-shielding wall, and
the left contacting portion includes a bottom face of a left recessed portion formed on the light-shielding wall.

10. The light-shielding member according to claim 8, wherein the nose accommodation portion is configured integrally with the light-shielding wall at a lower portion of the light-shielding wall.

11. A head-mounted display comprising:
a housing;
a mounting band that extends rearwardly from the housing and that is to be mounted on the head of a user; and
a light-shielding member that reduces external light to be incident to the eyes of the user, wherein
the light-shielding member includes a nose accommodation portion including a front portion, a right portion, and a left portion that cooperatively form a space in which the nose of the user is to be accommodated,
the right portion includes a right inclined portion that is inclined downwardly toward the right and that is to elastically come into contact with at least part of an inner side portion of a right lens edge of eyeglasses worn by the user, and
the left portion includes a left inclined portion that is inclined downwardly toward the left and that is to elastically come into contact with at least part of an inner side portion of a left lens edge of the eyeglasses worn by the user.

12. The head-mounted display according to claim 11, wherein
the light-shielding member further includes an attachment portion that is attached to the housing and a light-shielding wall projecting rearwardly from the attachment portion,
at least part of the nose accommodation portion is located in front of the attachment portion, and
the housing includes a recessed portion in which the part of the nose accommodation portion located in front of the attachment portion is arranged.
